(19) United States
(12) Patent Application Publication
(10) Pub. No.: US 2007/0041198 A1
(43) Pub. Date: Feb. 22, 2007

(54) Lamp assembly having a reflected component

(76) Inventor: Volker Teichmann, Amstetten (DE)

Correspondence Address: CLARK HILL, P.C., 500 WOODWARD AVENUE, SUITE 3500, DETROIT, MI, 48226, US

(21) Appl. No.: 11/506,626

(22) Filed: Aug. 18, 2006

(30) Foreign Application Priority Data
Aug. 18, 2005 (DE) 102005040227.5

(51) Int. Cl. F21V 7/00

(52) U.S. Cl. 362/297; 362/518; 362/346

(57) ABSTRACT

A lighting assembly includes a base and a reflector component fixedly secured to the base. A cover is fixedly secured to the reflector component. A light source is disposed between the reflector component and the cover. The light source emits light therefrom. The lighting assembly also includes a reflective surface applied to the reflector component between the reflector component and the base such that the light emitted by the light source is transmitted through the reflector component prior to being reflected toward the cover by the reflective surface.

### BACKGROUND ART

1. Field of the Invention

The invention relates to a lighting unit having a reflector component. More particularly, the invention relates to a lighting unit having a reduced volume.

2. Description of the Related Art

The use of lighting units and reflectors is known for motor vehicles. As a rule, the lighting units are installed as modules in which multiple lights, such as a back-up light, turn signal light, brake light, and the like are integrated. The reflector is used to selectively reflect, and optionally focus, the light emitted by a light source in a particular direction. Coated reflectors made of plastic are also currently known in which the side of the reflector facing the light source is typically coated with a thin layer of aluminum or chromium. The reflector or regions of a reflector component are designed as paraboloids (“reflector parabola”) to allow the light to exit in the most optimum parallel fashion. Multiple light sources may be provided for a reflector component, the reflector component for each light source having a paraboloidal region.

To obtain a desired coloration of the emitted light, a color filter may be placed over the light source, which itself has a matching color, or the cover of the lighting unit, such as a light diffuser, is correspondingly colored.

Reflector components of light assemblies have large volumes. This is due to the fact that the optics of a paraboloid require space to create beams of light exiting the light assemblies that are maximizing the amount of light directed in a particular direction.

### SUMMARY OF THE INVENTION

In the lighting unit according to the invention having a reflector component and at least one light source associated with the reflector component, a reflective surface associated with the reflector function of the reflector component is provided, at least in places, on the back side of the reflector component facing away from the light-exiting surface. Placing the reflective surface on the back instead of the front side results in greater optical depth of the reflector component, and therefore of the entire lighting unit, although the lighting unit may have a relatively flat geometric design. The reflector body may even have a particularly thick design in certain regions in order to intensify the effect. At the same time, increased thickness can enhance the stability of the reflector component. The reflective surface may be formed on the back side of the reflector component in particular by a metallic layer in which, for example, a protective layer such as a protective lacquer, a polymer layer, or the like may be provided to protect from damage.

It is practical for the reflector component to have a design that is transparent to optical wavelengths, at least in places. In these regions the back side is provided with a reflective surface, in particular a layer, which reflects in the desired direction the light emitted from the light source.

The reflector component may optionally be colored, at least in some places. As a result of the transparency of the reflector component and the coloring, the desired coloration of the emitted light may be obtained. This measure may also be combined with conventional color filters, colored light source, and so forth.

A high optical quality of the reflective surface may be achieved when the reflective surface is formed by a chemical vapor deposition (CVD) layer and/or a physical vapor deposition (PVD) layer. The reflective surface preferably is provided at an interface between the back side of the reflector component and the layer. It is particularly advantageous when the reflective layer is constructed out of aluminum, the aluminum preferably being provided as a vapor-deposited layer. This layer may be deposited on the reflector component at a high coating rate and moderate vaporization temperature. If the back side of the reflector component to be coated is given a mirror finish, a particularly brilliant reflection is achieved.

A qualitatively high-quality coating is possible when the back side of the reflector component is advantageously composed of essentially smooth, in particular mirror-finished, flat pieces.

Interfering shadow effects and layer inhomogeneities may thus be easily avoided in the coating. If the back side had a layered structure similar to the conventional front side of the reflector component, correspondingly steep surfaces would represent coating problem areas that would have to be taken into account during the coating. The flat pieces advantageously have a paraboloidal shape, at least in places, or are associated with paraboloidal regions of the reflector component for the light source of the lighting unit.

A front side of the reflector component facing the light-exiting surface preferably may have optically active surface structures, for example in the form of Fresnel lenses. The shape and configuration thereof may advantageously be adapted to the optical path of the light, emitted from a light source, which is altered with respect to a front side coating. Additionally or alternatively, the back side may likewise be provided with such optically active surface structures.

The reflective layer may have a thin design, with layer thicknesses corresponding to the particular method used. A preferred layer thickness is 1 μm maximum, preferably 100 nm to 1 μm, particularly preferably 10 nm to 100 nm. The layer thickness may also be only a few nim. These layer thicknesses may be easily achieved using the CVD and/or PVD method.

A compact module may be produced when at least two paraboloidal regions are provided inside the reflector component.

The reflector component for a lighting unit according to the invention has a reflective surface on the back side of its reflector body by which light from a light source may be reflected onto a light-exiting surface. The back side of the reflector component preferably has a metallic coating.

The reflector body may preferably be designed to be transparent to optical wavelengths. The front side may preferably be designed to be transparent to optical wavelengths.

An advantageous coloration may be achieved when the reflector body is colored at least in places.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a top view of one embodiment of a lighting unit incorporating the invention;

FIG. 2 is a cross-sectional side view of one embodiment of the invention; and

FIG. 3 is a side view, partially cut away, of a second embodiment of a lighting unit incorporating the invention.

### DETAILED DESCRIPTION OF THE PREFERRED EMBODIMENT

In the Figures, elements that are functionally equivalent are designated by identical reference numerals.

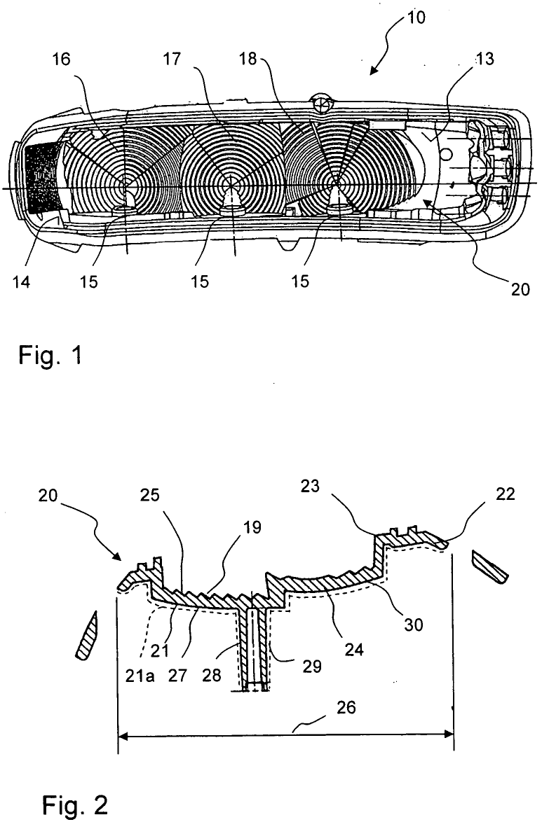

As seen in FIG. 1, a preferred lighting unit or assembly is generally shown at 10. The lighting assembly 10 includes a reflector component 20 having three regions 16, 17, 18 that are paraboloidal at least in places, whereby one light source (not illustrated) is associated with each paraboloidal region 16, 17, 18 and is respectively provided in a base 15 on the lateral, lower paraboloidal region 16, 17, 18. The base includes an electrical connecting means for the light source. The reflector component 20 is provided with a cover 14, designed as a light diffuser, which defines a light-exiting surface 13 of the lighting assembly 10. Optical structures having the appearance of grooves are situated in the paraboloidal regions 16, 17, 18. As a result of the optical structures and the specialized curvature of the paraboloidal regions 16, 17, 18, the light emitted from the light source that strikes the reflector component 20 is suitably reflected toward the light-exiting surface 13. In this manner, the light at the back side of the reflector component 20 is reflected onto a reflective surface situated at that location which is provided at the interface between a reflective layer made of a reflective material and the back side of the reflector component 20.

This is shown in greater detail in FIG. 2, with reference to a sectional illustration of a preferred reflector component 20. The reflector component 20 has a transparent reflector body 22, in particular made from plastic, having a reflective surface 21 between its back side 24, facing away from a light source (not illustrated), and a flat reflective layer 21a situated on the back side 24. Light emitted from the light source is reflected at the interface between the back side 24 and the layer 21a.

A front side 23 of the reflector component 20 includes a convex curvature with respect to the light source. The front side 23 also includes optically active structures 19 which influence the deflection and reflection of light in a desired manner known as such. The front side 23 has a paraboloidal region 25. On the coated back side 24 the reflector component 20 is relatively flat and in particular is formed from smooth, flat pieces 27, 28, 29, 30. The back side 24 of the reflector component 20 preferably has a mirror finish. This is advantageous for the quality of the reflective layer 21a in the coating process. The reflector component 20 is provided with the reflective layer 21a in a region 26. The reflector body 22 may advantageously be formed from a transparent plastic, preferably polymethylmethacrylate (P or polycarbonate (PC).

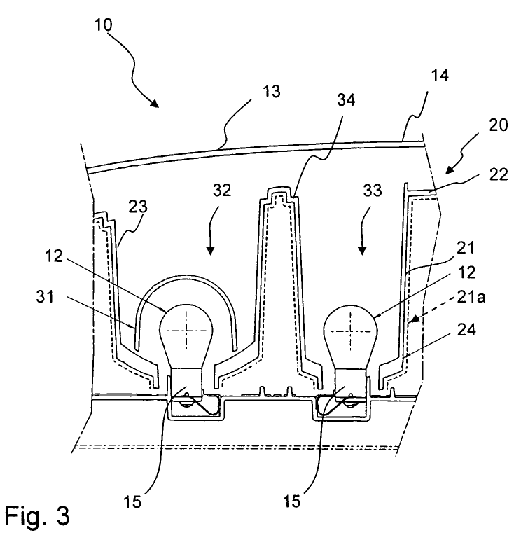

FIG. 3 shows in a sectional view a portion of an additional preferred lighting assembly 10 including a reflector component 20 having a reflector body 22. Paraboloidal regions 32, 33 of the reflector component 20, in each base point of which a base 15 is provided for light source 12, have a deeper design than in the previous exemplary embodiment. The two paraboloidal regions 32, 33 are separated by a partition 34.

One of the light source 12 is covered by a color filter 31 to achieve a desired colored effect when light is transmitted therethrough. A reflective layer 21a, preferably an aluminum vapor deposition layer, is planarly provided on a back side 24 of the reflector component 20. A reflective surface 21 is formed between the layer 21a and the back side 24. Here as well, the back side 24 of the reflector component 20 is composed of essentially smooth, in particular mirror-finished, flat pieces not described in greater detail, thereby simplifying the vapor deposition process.

In this embodiment, a front side 23 of the reflector component 20 facing the light-exiting surface 13 has a relatively smooth design. The reflective layer 21a on the back side 24 preferably has a small layer thickness, as can typically be produced by CVD or PVD. A protective layer, not illustrated, for protecting the layer 21a may optionally be provided.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

### LIST OF REFERENCE NUMERALS

10 Lighting unit
12 Light source
13 Light-exiting surface
14 Cover
15 Base
16 Paraboloidal region
17 Paraboloidal region
18 Paraboloidal region
19 Optically active structure
20 Reflector component
21 Reflective surface
21a Layer
22 Reflector body
23 Front side
24 Back side
25 Paraboloidal region
26 Coated region
27 Smooth flat piece
28 Smooth flat piece
29 Smooth flat piece
30 Smooth flat piece
31 Color filter
32 Paraboloidal region
33 Paraboloidal region
34 Partition

1-13. (canceled)

14. A lighting assembly comprising:
a base;
a reflector component fixedly secured to said base;
a cover fixedly secured to said reflector component;
a light source disposed between said reflector component and said cover, said light source emitting light therefrom; and
a reflective surface applied to said reflector component between said reflector component and said base such that the light emitted by said light source is transmitted through said reflector component prior to being reflected toward said cover by said reflective surface.

15. A lighting assembly as set forth in claim 14 wherein said reflector component is transparent.

16. A lighting assembly as set forth in claim 15 wherein portions of said reflector component include color pigment therein.

17. A lighting assembly as set forth in claim 16 wherein said reflective layer is fabricated using chemical vapor deposition.

18. A lighting assembly as set forth in claim 16 wherein said reflective layer is fabricated using physical vapor deposition.

19. A lighting assembly as set forth in claim 16 wherein said reflector component includes a front side.

20. A lighting assembly as set forth in claim 19 wherein said front side includes optical components to further direct the light emitted by said light source.

21. A lighting assembly as set forth in claim 20 wherein said reflector component includes a plurality of paraboloidal regions.
